(19) United States
(12) Patent Application Publication
(10) Pub. No.: US 2002/0191094 A1
(43) Pub. Date: Dec. 19, 2002

(54) CCD clock alignment circuit using a frequency locked clock multiplier

(75) Inventors: Lucas P. Curtis, Churchville, NY (US); Thomas J. Manning, Farmington, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/870,336

(22) Filed: May 30, 2001

(51) Int. Cl. H04N 3/14

(52) U.S. Cl. 348/312

(57) ABSTRACT

A clock synthesizing circuit for generating clock signals for driving a pixel-based image sensor includes a pixel rate generator that generates a master clock having a master clock frequency corresponding generally to a readout rate of the image sensor, a frequency locked loop that receives the master clock and generates a high frequency clock operating at a multiple of the master clock frequency, and a clock generation circuit that utilizes the high frequency clock to generate a plurality of low frequency clock signals for driving the image sensor. The frequency locked loop may be either a phase locked loop or a delay locked loop, and the clock generation circuit would utilize the edge transitions of the high frequency clock to generate the low frequency clock signals for driving the image sensor.

### FIELD OF THE INVENTION

The present invention relates to the field of clock signal generation, and in particular to synthesizing digital clock signals for an image sensor.

### BACKGROUND OF THE INVENTION

A variety of clock signals are required to operate a solid state image sensor circuit, such as a charge-coupled device (CCD), including clocks for the shift register phases, output reset gate, correlated double sampling (CDS) and analog to digital converter (ADC). Although these clocks will all normally run at the same fundamental frequency (the readout rate of the image sensor), they have different requirements for duty cycle and phase. The duty cycle and phase must be controlled by carefully positioning the rising and falling edges of the clock signals relative to one another. A typical set of CCD clock timing signals is illustrated in FIG. 1.

One previous method used for positioning of these clock edges relative to one another is through the use of analog delay lines. This method enables accurate positioning of clock edges, but it is expensive, has a high component count, requires a high circuit board area, and is difficult to reconfigure. Another method has been to start with a multiple of the readout clock rate as a master clock, and then to align the CCD clock edges to transitions of the master clock. (This technique is shown in commonly assigned U.S. Pat. No. 5,847,588, entitled “Programmable Multiple CCD Clock Synthesizer” and issued Dec. 8, 1998 in the name of B. McDermott.) This method has the advantage of being reconfigurable through software or programmable logic, but provides only a finite set of clock edge positions to choose from. The higher the multiple of the pixel clock rate, the more time slots to choose from. However, the high frequency master clock may cause problems with electromagnetic interference, especially as the clock rates of digital imaging devices continue to increase dramatically over time.

### SUMMARY OF THE INVENTION

The present invention is directed to overcoming one or more of the problems set forth above. Briefly summarized, according to one aspect of the present invention, a clock synthesizing circuit for generating clock signals for driving a pixel-based image sensor includes a pixel rate generator that generates a master clock having a master clock frequency corresponding generally to a readout rate of the image sensor, a frequency locked loop that receives the master clock and generates a high frequency clock operating at a multiple of the master clock frequency, and a clock generation circuit that utilizes the high frequency clock to generate a plurality of low frequency clock signals for driving the image sensor. The frequency locked loop may be either a phase locked loop or a delay locked loop, and the clock generation circuit would utilize the edge transitions of the high frequency clock to generate the low frequency clock signals for driving the image sensor.

An approach has thus been developed for using phase-locked loop (PLL) or delay-locked loop (DLL) clock multiplier circuits to generate a high frequency master clock from a low frequency pixel readout clock. The high frequency clock is then used to accurately position the edges of low frequency clock signals to drive a solid state image sensor and associated electronics.

One advantage of the invention is that the PLL circuit can be local to the clock generation circuitry, minimizing the potential for electromagnetic interference. In addition, since in an application specific IC (ASIC) implementation or in some field programmable gate array (FPGA) devices (i.e. Apex from Altera and Virtex from Xilinx) programmable PLL's are built right into the integrated circuit, the invention may be implemented so that the high frequency master clock remains entirely internal to the device, greatly reducing the possibility of electromagnetic interference.

### BRIEF DESCRIPTION OF THE DRAWINGS

FIG. 1 shows a typical set of CCD clock timing signals.

FIG. 2 shows a block diagram of an imaging subsystem using a frequency locked clock multiplier as part of its clock generation circuit.

FIG. 3 shows a block diagram of a conventional phased lock loop (PLL) used for the clock multiplier shown in the imaging subsystem of FIG. 2.

FIG. 4 shows a block diagram of an imaging subsystem of the type shown in FIG. 2 with feedback from the clock generation circuit to the clock multiplier.

FIG. 5 show a block diagram of a clock generation circuit of the type that can be used in the imaging subsystem shown in FIG. 2.

FIG. 6 shows a block diagram of a conventional delay locked loop (DLL) used for the clock multiplier shown in the imaging subsystem of FIG. 2.

### DETAILED DESCRIPTION OF THE INVENTION

Because imaging devices employing clock generation circuits are well known, the present description will be directed in particular to elements forming part of, or cooperating more directly with, apparatus in accordance with the present invention. Elements not specifically shown or described herein may be selected from those known in the art.

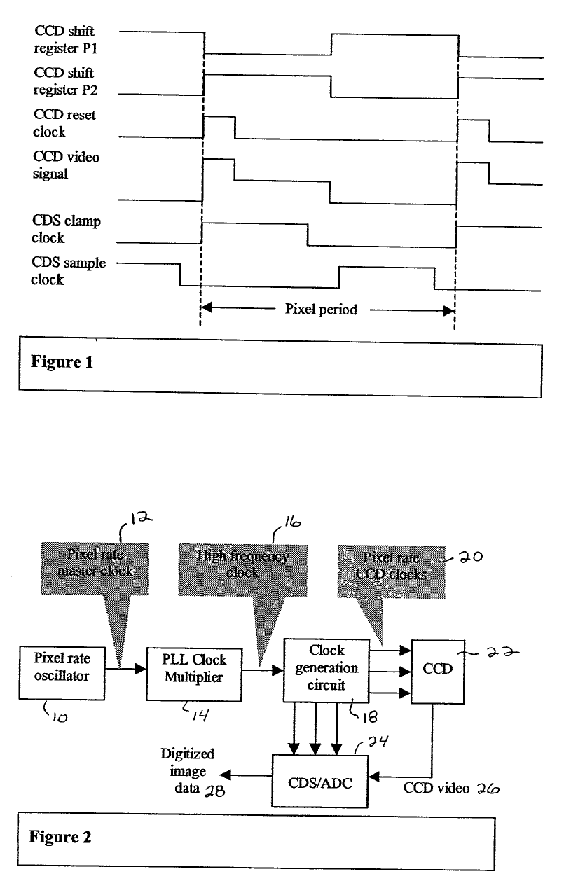

Referring to FIG. 2, a block diagram of an imaging subsystem shows use of a frequency locked clock multiplier as part of a clock synthesizing circuit in accordance with the invention. More specifically, FIG. 2 shows a first embodiment in which a pixel rate oscillator 10 drives a pixel rate clock signal 12 to a phase locked loop (PLL) clock multiplier circuit 14, where a high frequency master clock 16 is generated at an integer multiple N of the pixel clock rate. The high frequency master clock 16 is fed to a clock generation circuit 18, which generates the pixel rate CCD drive signals 20, each with the appropriate duty cycle and phase for efficient operation of a CCD sensor 22. Exemplary CCD drive signals 20 are shown as the CCD shift register P1, CCD shift register P2 and CCD reset clock signals in FIG. 1.

The clock generation circuit 18 also generates the necessary drive signals (e.g., the CDS clamp clock and the CDS sample clock signals shown in FIG. 1) to operate subsequent pixel processing circuitry, such as a correlated double sampling circuit and an analog to digital converter shown together as a circuit 24, which converts the CCD video signal 26 from the CCD sensor 22 to digitized image data 28. It is helpful to understand that the pixel rate oscillator 10 is designed to generate a train of pulses corresponding to the fundamental frequency (the readout rate) of the CCD sensor 22. The PLL clock multiplier 14 includes a phase locked loop that provides frequency multiplication of the output of the pixel rate oscillator 10. This avoids the problem of providing a high frequency master clock that may cause problems with electromagnetic interference.

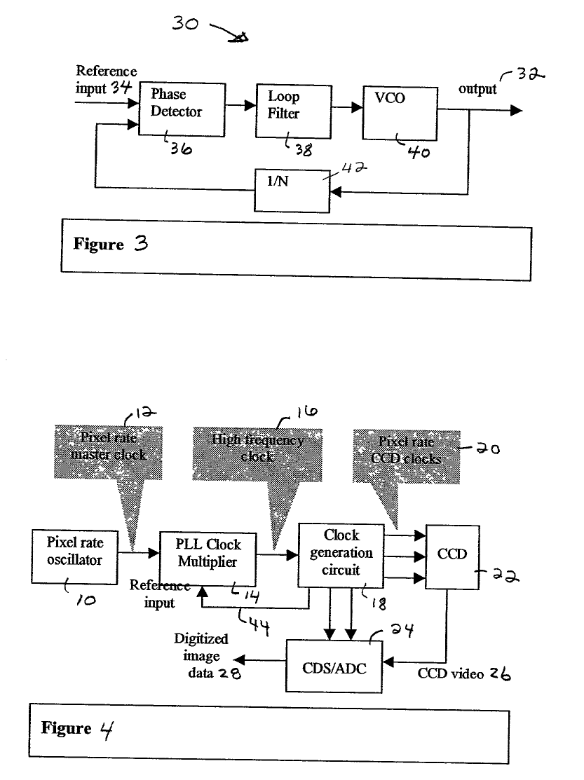

A phase locked loop (PLL) 30, as shown in FIG. 3, is a circuit that uses feedback to maintain an output signal 32 in a specific phase relationship with a reference signal 34. PLL circuits are commonly used for performing on-chip clock multiplication, zero skew clock distribution and clock recovery. Components of the PLL 30 include a phase detector 36, a loop filter 38, a voltage controlled oscillator (VCO) 40 and a frequency divider 42 that provides an input signal to the phase detector 36. The phase detector 36 produces an output voltage proportional to the phase difference between its two input signals. The loop filter 38 controls the response of the system, in order to drive the phase difference between the two inputs to zero. The VCO 40 produces an AC output 32 whose frequency is proportional to an input voltage. The frequency divider 42 divides the frequency of the output to match the reference input frequency. Thus, the output frequency 32 is a multiple N of the reference frequency 34. Further details of phase-locked loops can be found in many texts, for example The Art of Electronics, Second Edition, P. Horowitz and W. Hill, Cambridge University Press: 1989, pp. 641-655.

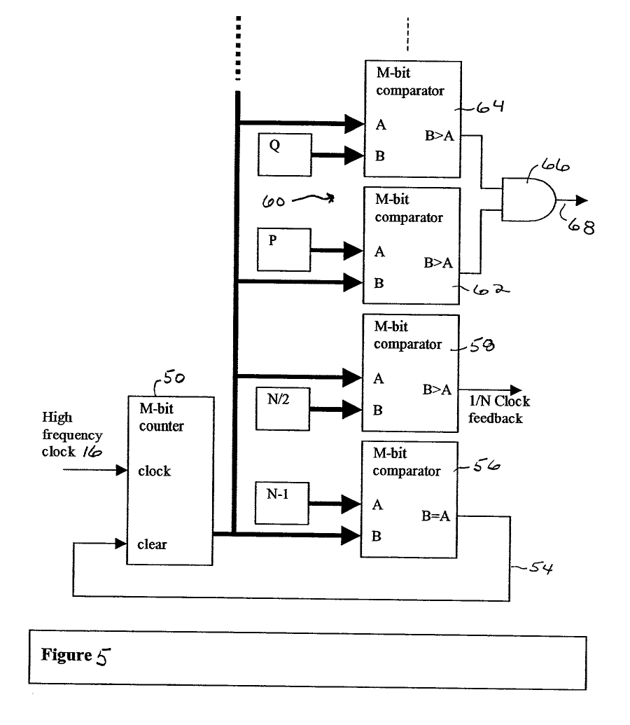

There are different methods for implementing the clock generation circuit 18. The aforementioned U.S. Pat. No. 5,847,588, which is incorporated herein by reference, describes a method using logical combinations of delayed pulses. Another approach is to use a sub-pixel counter which feeds sets of comparators. In fact, one of the outputs 44 of the clock generation circuit can be used as the clock divider in the feedback path of the PLL, as shown in FIG. 4. This ensures synchronization of the clock generation circuit 18 with the pixel rate master clock oscillator 10 as well.

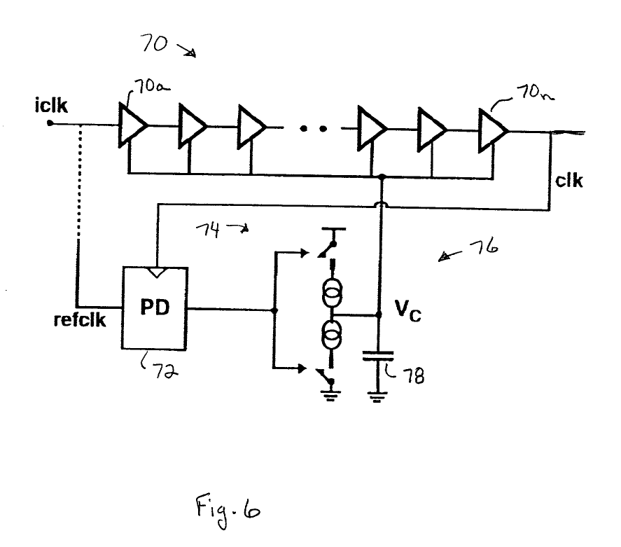

A clock generation circuit 18 as described above for the latter approach is shown in FIG. 5. An M-bit counter 50 is clocked by the high frequency clock 16 from the PLL clock multiplier 14. On each rising clock edge the count value is incremented by one. The output count value is fed to a series of comparators 56-64. The output 54 of the first comparator 56 is fed back to the synchronous clear input of the counter, such that when the count value is equal to N−1, the output of the comparator 56 is asserted, clearing the counter value back to zero on the next clock edge. The output of the second comparator 58 is asserted when the count value is less than N/2. Thus this output will switch at the original pixel clock rate, and can be fed back to the reference input of the PLL (line 44 in FIG. 4). The outputs of comparator pair 60, comprising comparators 62 and 64, are logically combined in an AND gate 66 to form a pixel rate CCD clock 68 with programmable rising and falling edge positions. An arbitrary number of comparator pairs may be added to the circuit to produce additional clock signals, each with independently programmable rising and falling edge positions. In practice, the output of the logical combination of comparators may be registered to eliminate positioning error due to combinatorial delay. Together, these comparator pairs form CCD timing signals of the type shown in FIG. 1.

This clock generation approach has the additional advantage that the values of N, P, Q, etc. can be implemented as programmable registers, greatly simplifying reconfiguration of the circuit via software.

The first embodiment of the invention shown in FIG. 2 employs a phase locked loop as the frequency locked clock multiplier. In a second embodiment, a conventional delay locked loop (DLL) as shown in part in FIG. 6 may be used in place of the PLL as the clock multiplier 14. A DLL includes a voltage controlled delay line 70, a phase detector 72, a charge pump 74 and a first-order loop filter 76. The input reference clock iclk drives the delay line 70, which comprises a number of cascaded variable delay buffers 70a . . . 70n. The output clock clk drives the loop phase detector 72. The output of the phase detector 72 is integrated by the charge pump 74 and the loop filter capacitor 78 to generate the loop control voltage V_{c}. The loop negative feedback drives the control voltage to a value that forces a zero phase error between the output clock clk and the reference clock iclk. Further details of delay-locked loops can be found in an article by Sidiropoulos and Horowitz, “A Semidigital Dual Delay-Locked Loop”, IEEE Journal of Solid-State Circuits, Vol. 32, No. 11, November 1997, pp. 1683-1692.

The invention has been described in detail with particular reference to certain preferred embodiments thereof, but it will be understood that variations and modifications can be effected within the spirit and scope of the invention.

PARTS LIST

| | |
|---|---|
| 10 | pixel rate oscillator |
| 12 | pixel rate clock signal |
| 14 | clock multiplier circuit |
| 16 | high frequency masterclock |
| 18 | clock generation circuit |
| 20 | CCD drive signals |
| 22 | CCD sensor |
| 24 | correlated double sampling/ |
| | analog to digital converter circuit |
| 26 | CCD video signals |
| 28 | digitized image data |
| 30 | phase locked loop circuit |
| 32 | output signal |
| 34 | reference signal |
| 36 | phase detector |
| 38 | loop filter |
| 40 | voltage controlled oscillator |
| 42 | frequency divider |
| 44 | output |
| 50 | m-bit counter |
| 54 | output |
| 56 | first comparator |
| 58 | second comparator |
| 60 | comparator pair |
| 62 | third comparator |
| 64 | fourth comparator |
| 66 | AND gate |
| 68 | pixel rate clock |
| 70 | voltage controlled delay line |
| 70a . . . 70n | variable delay buffers |
| 72 | phase detector |
| 74 | charge pump |
| 76 | first-order loop filter |
| 78 | loop filter capacitor. |

What is claimed is:

1. A clock synthesizing circuit for generating a plurality of lower frequency clock signals from a higher frequency clock for driving a pixel-based image sensor, said synthesizing circuit comprising:
a pixel rate generator that generates a master clock having a master clock frequency corresponding generally to a readout rate of the image sensor;
a frequency locked loop that receives the master clock and generates a high frequency clock operating at a multiple of the master clock frequency; and
a clock generation circuit that utilizes the high frequency clock to generate a plurality of low frequency clock signals for driving the image sensor.

2. The clock synthesizing circuit as claimed in claim 1
wherein the frequency locked loop is a phase locked loop.

3. The clock synthesizing circuit as claimed in claim 1
wherein the frequency locked loop is a delay locked loop.

4. The clock synthesizing circuit as claimed in claim 1
wherein the clock generation circuit utilizes the edge transitions of the high frequency clock to generate the plurality of low frequency clock signals for driving the image sensor.

5. The clock synthesizing circuit as claimed in claim 1
wherein the clock generation circuit generates a high frequency shift register clock for reading out the image sensor.

6. The clock synthesizing circuit as claimed in claim 1
wherein the clock generation circuit generates a high frequency reset clock for the image sensor.

7. The clock synthesizing circuit as claimed in claim 1
wherein the clock generation circuit includes a counter driven by the master clock that feeds one or more comparator pairs whose outputs are logically combined to form one or more pixel rate clocks with programmable rising and falling edge positions.

8. The clock synthesizing circuit as claimed in claim 1
wherein the clock generation circuit further generates one or more further low frequency clock signals for driving electronics associated with the image sensor.

9. The clock synthesizing circuit as claimed in claim 8
wherein the clock generation circuit generates high frequency clamp and sample clocks for a correlated double sampling circuit.

10. The clock synthesizing circuit as claimed in claim 8
wherein the clock generation circuit generates a high frequency clock for an analog to digital converter circuit.
